(19) United States
(12) Patent Application Publication
(10) Pub. No.: US 2006/0180707 A1
(43) Pub. Date: Aug. 17, 2006

(54) Spacecrafts sculpted by solar beam and protected with diamond skin in space

(76) Inventor: Benjamin F. Dorfman, San Francisco, CA (US)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(21) Appl. No.: 11/266,334

(22) Filed: Nov. 4, 2005

Related U.S. Application Data
(60) Provisional application No. 60/625,353, filed on Nov. 5, 2004.

(51) Int. Cl. B64G 1/00

(52) U.S. Cl. 244/158.1

(57) ABSTRACT

The invention discloses employment of artificial glass and obsidian as construction materials for structures of spacecrafts and for structures on the outer celestial bodies. The pre-designed shape of said structures is formed by the focused solar irradiation while the forming structures undergo to a broader distributed solar irradiation providing the internal air or gas pressure; same technique employed to repair the space structures; accordingly to other embodiment, this technique employed for thermoplastic inflatable structures rigidized in space. Obsidian may be also produced artificially by melting natural rocks on the surface of the celestial bodies by focused solar irradiation. Accordingly to the present disclosure, obsidian is a natural glass-nanocrystalline material with predominantly 2D superficial fracture vs. 1 d radial cracks in common glass; that results with superior properties of obsidian and allows further improvements in artificially made glasses. Also disclosed is the on-orbit deposition of smart coatings improving mechanical properties of glass and also providing a functionally distributed variation of optical and/or electrical surface properties of space structures. Moreover, the disclosed coatings technique may be employed to rigidize plastics and to protect plastic structures from such aggressive agents as atomic gases. In addition, semi-rigid armature as a chain armor reinforces the entire structure; the chain armor is self-shaping under a tensile force provided by an inflatable internal structure.

The present application claims the benefit of U.S. Provisional Application No. 60/625,353, filed Nov. 5, 2004, the entire contents of which are incorporated herein by reference.

### FIELD OF THE INVENTION

This invention pertains to the field of materials, technology and design for space crafts and for structures built on the outer celestial bodies. In particular, the disclosed invention is designated for space crafts of any size, from miniature satellites to very large stations acquiring their functional shape with or virtually without assembling and superficially protected while orbiting. More specifically, this application pertains to the use of structural materials and related techniques which were never employed for this applications by the prior art. It is also aiming the autonomic space technology powered by the solar energy and potentially furnished with raw materials that are easy available on the surface of Moon and outer planets. It is also addressing the following goals: on-orbit assembly of large space structures and self assembling systems, inflatable packages and modular spacecraft; establishment of large geosynchronous sensor bases. Besides, it will eventually address establishing of interactive archipelagos of large space stations. Predominantly, the proposed inventions concerns with satellites that orbit above 1000 km possessing virtually unlimited life in space, spacecrafts designated for remote space missions, and structures built on the ground of the outer celestial bodies.

### BACKGROUND OF THE INVENTION

In the field of space materials and technology there is incessant pressure to decrease the weight and size of the apparatuses launched from the Earth and to save the energy required for launch. This pressure becomes progressively stronger while the scale of space missions increases. It becomes an ultimate demand with respect to the structures projected on the outer celestial bodies.

In the prior art, all the structural materials required for space missions produced on the Earth. Predominantly, these structural materials are metals. Although other materials such as ceramics, glass, carbon-based parts, crystalline wafers, and plastics used for insulation, windows, solar batteries, various device, typically they contribute to the only inferior portion of the structural bodies of crafts.

Recently, plastics became essential subjects of structural materials development for space crafts, especially in the form of shell-like inflatable structures. However, plastics undergo to fast degradation in space under various irradiation and chemical attacks of atomic gases, in particular atomic hydrogen and atomic oxygen. Plastic also need to be rigidized in space after acquiring the shape.

It is well known from a number of official publications by the NASA, the Robotic missions to the Moon would begin no later than 2008, followed by an extended human expedition as early as 2015. Lunar exploration would lay the groundwork for future exploration of Mars and other destinations. These strategic tasks in space exploration require novel principle in materials design and shape-forming technology ultimately targeting the sources of raw materials and energy available in space.

For the reasons stated above, and for the reason stated below which will become apparent to those skilled in the art upon reading and understanding the present specification, there is a significant need in the art of fabricating structural materials in space, use the raw materials available on the outer celestial bodies and providing said materials with the pre-designed shape and surface properties using solar irradiation as the industrial sources of energy available in space.

### BRIEF DESCRIPTION OF THE DRAWINGS

FIG. 1 schematically illustrates difference in micro-fracture behavior of conventional glass and dark obsidian accordingly to the present invention. Shown is sequence of comparative schematic images of micro-fracture in obsidian (right column of the images) vs. schematic images of micro-fracture in artificial glass under Vickers diamond pyramid at the respectively equal loads as indicated. Accordingly to this patent disclosure, the schematic images of micro-fracture in artificial glass as shown on FIG. 1 are correct for all examined kinds of artificial glass, including lime glass of different qualities and fused quartz, although the respective specific values of the crack threshold, fracture toughness and crack arrest toughness are slightly differentiate in the above indicated different kinds of artificial glass.

FIG. 2 illustrates the flowchart for fabricating space structure from artificial or natural glass accordingly to the present invention.

FIG. 3 schematically illustrates an example of the semi-rigid armature reinforcing the glass and/or thermoplastic structure in space. Also shown are comparative sizes of reinforcing rings with respect to the entire armature-reinforced structure.

FIG. 4 schematically illustrates the deposition of smart coatings upon the space structure as follows: 1. Space structure; 2. Multi-cascade remote plasmatron with multi-chamber vacuum system and graduated transition from ˜0.01 Pa in central discharge to ˜1.0 micro-Pa in the external chamber; 3. Flux of energetic precursor radicals generated by the remote plasmatron; 4. Solar batteries; 5. Tank with precursors; and 6. Mirror reflecting and focusing the solar irradiation onto the respective components of said plasmatron and the precursors feeding inlet.

### DETAILED DESCRIPTION OF THE INVENTION

The invention discloses employment of artificial glass and natural glasses, especially volcanic glass or obsidian, as the basic construction materials for spacecrafts and for structures built on the outer celestial bodies. The invention also concerns with thermoplastics with respect to the new technologies as disclosed in claims and below.

Glass, as well as thermoplastics, represent materials which may acquire a complex shape without mechanical treatment or assembling. Differently from metals or ceramics, they do not require the local mechanical forces forming their shape, but only local heating under a global internal pressure. Accordingly to the present invention, a hollow structure filled with gas may be transformed to virtually any required shape in space using solar irradiation focused by reflectors. Thus, the shape-forming technique based on solar energy and pre-designed and programmed movements of remote reflectors will provide the actually designated space technology.

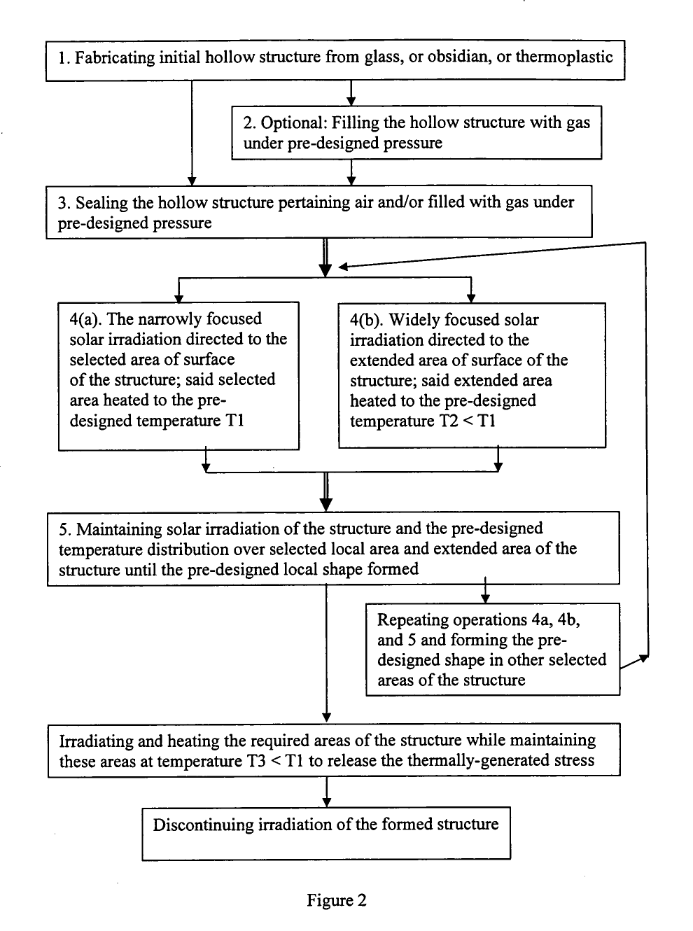

The process of creating said pre-designed shape of said structures (FIG. 2) begins from fabricating of an initial hollow structure, filling said hollow structure with gas or simply retaining an atmospheric air pressure in said hollow structure, and sealing said hollow glass or obsidian structure containing a gas. These initial steps of fabricating the structures accordingly to the present invention may be realized on the Earth ground with the following launch of pre-formed initial structure into the open space, or said initial steps may be realized on the land platforms of the outer celestial bodies. The pre-designed final shape of said structures is formed by the focused solar irradiation; said focused solar irradiation increases the local temperature of the structure and therefore locally transforms said artificial or natural glass material or thermoplastic material into a soft viscous matter while the same heating technique is simultaneously applied and distributed over a larger area of the surface of said structure therefore increasing the average temperature of the air or other gas encompassed therein and hence providing internal pressure inside of said hollow sealed structure; said local focused heating of said structure combined with said heating distributed over a larger area of the surface of said structure results with local expansion of said structure in said locally heated area up to pre-designed limit; said pre-designed locally focused heating combined with said pre-designed limit of the local expansion of said materials defines the respective pre-designed local shape in said local area; subsequently, the heating is discontinued or decreased, and the material in said local area becomes rigid again thus preserving the provided pre-designed shape.

This technique may be employed repeatedly or simultaneously to different areas of the structure until the entire required pre-designed shape of said structure is formed. Finally, said structure may be opened and out-gassed or remain sealed with gas remaining in its interior correspondingly to specific technical requirements. Also accordingly to the present patent disclosure, the similar local heating technique as described above is employed to repair the space glass structures. Glass, especially the kinds of glass possessing low coefficient of thermal expansion which includes most of obsidian compositions, may be easily repaired in space by the above described local heating with focused solar irradiation up to the respective softening temperature ranges. It should be also pointed that many kinds of glass, especially obsidian, are virtually everlasting materials even in the remote space mission time terms, while the accidental damages (cracks) in glass structures may be easily cured with the above described solar beam technique. In addition, visibility and accessibility of the external structure provides strong advantage in their maintenance. Furthermore, some brittleness of certain components of the structure may even serve as desired property localizing the possible shock. Afterward, glass structure may be easily sealed with the same or specifically designated solar beam devices.

It should be noted that the light-heating technique, in particularly the focused solar irradiation, is well known by the prior art including vacuum conditions and heating up to 3000 C. Accordingly to the present invention, this technique employed for shape-forming processing in space using internal gas pressure controlled by similar irradiation heating without or with minimum use of mechanical forces; mechanical forces would be required for special purposes only, such as drawing for elongation of the entire structure or its arms.

According to other embodiment, the same technique as described above is employed for thermoplastics inflatable structures rigidized in space. Also accordingly to the present invention, obsidian for said structures is produced artificially on the surface of the outer celestial bodies, such as Moon or Mars, or other planets, or natural satellite, or asteroid, possessing solid land platform; said artificial obsidian is fabricated by melting natural rocks on the surface of said outer celestial bodies by the focused solar irradiation. Accordingly to one embodiment, the structure built of glass, or obsidian, or thermoplastic with a pre-designed desired shape of said structure formed by the focused solar irradiation accordingly to the description above, is realized with ultra-light weight reflectors, said with ultra-light weight reflectors installed in free space on spacecrafts.

According to another embodiment, the structure built of obsidian realized with reflectors installed on the surface of the outer celestial body, said reflectors maid of natural or artificially fabricated obsidian fabricated as stated above. Although both artificial common glass and natural or artificial obsidian may be employed as construction materials for space structure accordingly to the present disclosure, the natural volcanic glass or artificial obsidian, in particular dark-colored kinds of obsidian represent the primarily feasible materials for the purpose of this invention.

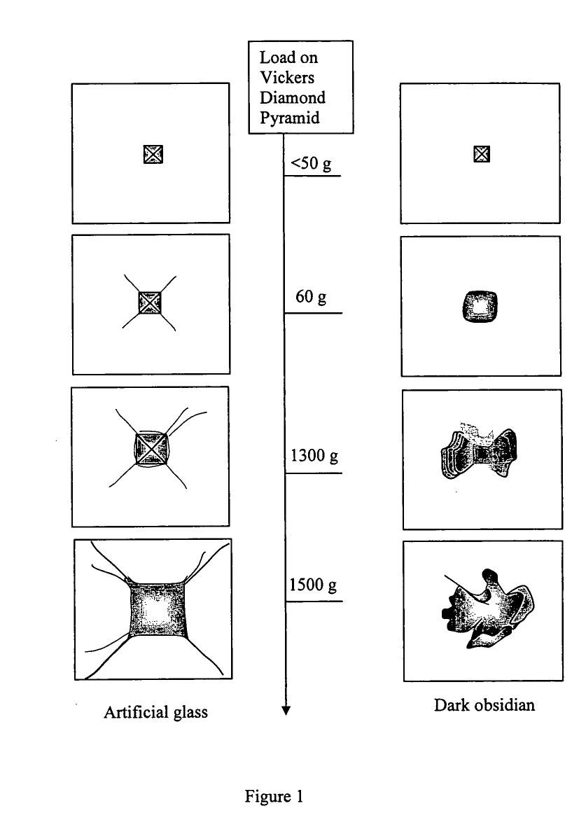

According to this invention, obsidian, especially dark-colored kinds of obsidian, are the natural glass-nanocrystalline structured materials possessing superior mechanical properties with respect to common uniform glass. Particularly, the micro-fracture behavior of obsidian was examined by the Vickers diamond pyramid method and accordingly to this invention demonstrated superior characteristics of micro-fracture vs. any kind of examined artificial glasses, as shown on FIG. 1. It was consistently found that the fracture pattern of volcanic glass is strongly differentiated from artificial glass—both lime glass and fused quartz. Up to extremely high threshold of ˜13 N, the basic mechanism of fracture in obsidian is predominantly two-dimensional superficial vs. quasi one-dimensional deep radial cracks typical for artificial glass. The crack-arrest fracture toughness of volcanic glass is exceedingly high vs. artificial glass. Contrary to usual radial cracks dominating in glass from threshold of about 0.6 N and up to maximum examined value of 15 N, the glass-like fracture pattern had been clearly revealed in obsidian only at load exceeding certain threshold of about 13 to 14 N. The minimum fracture toughness of obsidian vs. linear cracks was found in the range of: K≧1.6 MPa√m to K≧3.9 MPa√m while the maximum values essentially exceed the above indicated ones. For a comparison, the fracture toughness of glass and fused quartz with the same diamond indenter found in this examination in a good agreement with the reference data which may be found in science and technical literature [such as B. Lawn, Fracture Behavior of Solids, Cambridge University Press, 1993, or Bharat Bhushan, Nanomechanical Properties of Solid Surfaces and thin Films, 321-396, in Handbook of Micro/Nano Tribology, Bharat Bhushan ed., CRC Press, Boca Raton, 1995] are the following: polished optical glass: K=0.84 MPa√m; fused quartz: K=0.64 MPa√m.

All these distinguishing micro-mechanical features of volcanic glass are due to a network of micro-inclusions providing obsidian with structural and mechanical characteristic of a natural {glass|nano-crystalline} composite. Correspondingly and accordingly to this patent disclosure, all those features were not found in homogenous artificial glasses of the same chemical composition as the tested obsidian.

Also according to the present invention, the above described features of obsidian deriving from its nano-composite structure may be used for fabricating of artificial glass with superior vs. conventional glass mechanical properties, especially fracture toughness, crack arrest toughness, shock resistance, as well as improved high temperature mechanical properties. Typically, all the hard materials, metals, glass, and ceramics, undergo thermal annealing after shape forming procedures. This suggests a difficult challenge in space. However, such requirements are simplified or may be avoided with respect to low thermal expansion kinds of glass containing relatively high percentage of silica, such as obsidian, while relatively high temperature of their melting does not imply a serious challenge for solar beam heating.

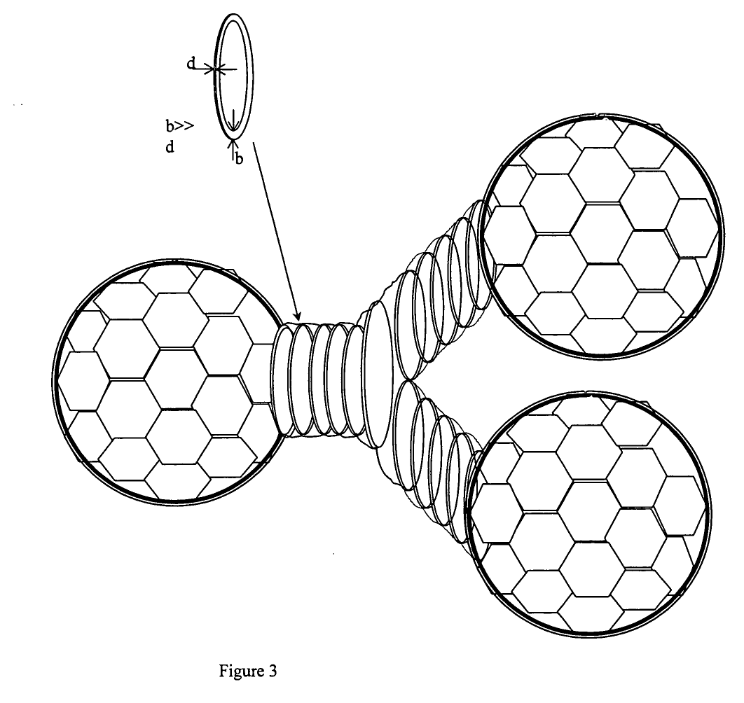

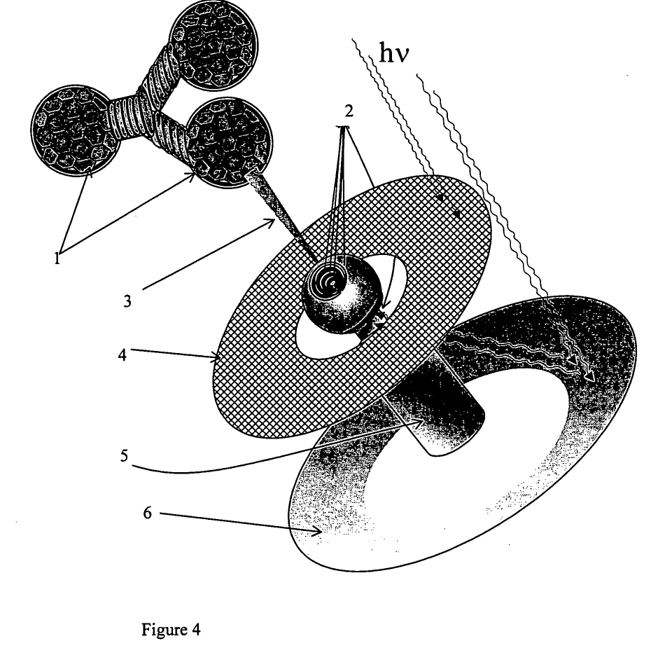

The major limitations for the disclosed space technology are specific properties of the employed materials: glass is not sufficiently flexible, while plastic is not sufficiently rigid. First may result with oscillations and complex vibrations of plastic structures under even relatively minor maintenance shocks, and a danger of crack formation in large glass structures. Besides, plastics undergo degradation under attacks of UV-irradiation, atomic hydrogen and atomic oxygen. The present invention discloses three major approaches for these problems solution: smart armature (FIG. 3), smart coatings deposited in space (FIG. 4) or on the land platform of the outer celestial bodies, and hybrid thermoplastic-glass structures encompassing the functionally graded plastic-to-glass interfaces.

The glass pipes with functionally graded compositions (such as fused quartz-lime glass) are well known by the prior art and used over nearly century. Development of glass with gradual transition from quartz to solid silicon-organic plastic is possible and will create a new strong base for space technology described in this patent disclosure. The structures comprising said glass and/or obsidian components and incorporating the plastic components integrated with said glass and/or obsidian components by means of functionally graded transitions (interfaces) glass-to-plastics, said plastics are preferably selected from silicon-organic family of plastics, represents effective solution of the brittleness problem of glass and alike materials in space constructions.

Also disclosed in this patent is semi-rigid armature as chain armor, said armor reinforces the entire glass and/or thermoplastic structure; the chain armor is self-shaping under a tensile force providing by inflatable internal structure. The smart armor system combined rigid and flexible components inside of glass or plastic inflatable structures will protect them from internal shocks, and it will protect the interior against the losses of air in the case if crake still occurred. Also disclosed the on-orbit deposition coating technique rigidizing plastics while increasing flexibility, shock- and thermal shock resistance of glass. The disclosed coatings technique also provides a functionally distributed variation of optical and/or electrical surface properties of space structures; it also protects structures from such aggressive agents as atomic oxygen.

The disclosed surface nano-engineering with novel Stabilized Synergetic Carbon (SSC) matters may change the face of many classical materials and scope of their implementation. The major mechanical properties of the coatings are equal to corresponding properties of steel (module, stiffness), while hardness and erosion resistance are strongly superior, and specific gravity is below of ¼ of steel (e.g. it is about or below 2.0 g/cm³). Hard, flexible, chemically and thermally stable coatings possessing adhesion, exceeding intrinsic strength of the substrate, become a perpetual skin transforming the coated structure similarly to natural skin or shell protecting a gentle flesh of the live organisms. In particular, glass and plastic become feasible construction materials for space crafts. The synergetic carbon structure is stabilized by silicon-oxygen network of atomic scale, that makes this material highly resistant to atomic oxygen. The proposed coatings will provide effective protection of the coated polymers from this aggressive agent in space. Complete protection of the substrate in the entire range of UV irradiation including vacuum UV, as well as effective protection from short-wave visible irradiation may be provided with coatings possessing thickness not exceeding 1.0 micrometers. The coating weight is not essential with regard to the coated substrate materials.

The SSC coatings are versatile with regard to their mechanical and other properties. Superficially, all the coated substrates become harder, but their bulk behavior may be changed differently. For instance, plastics can be made more rigid, while the glass sheets and even crystal wafers—to some extend more flexible, and their shock—and thermal shock resistance increases. Simultaneously, coatings provides complete anti-UV protection of substrate materials (in particular, plastics) as well as future personnel and sensitive devices inside of the structure. By variation of structure, thickness and doping of the coatings, a partial or complete blocking of visual radiation may be provided as well, while reflectivity may be tailored from over 95% to below 5%, depending on technical requirements for specific area of the craft exterior (i.e., optical and heat insulation or heating, anti-reflection coating for optical windows, etc.). Thus, the exterior surface may be locally transparent or opaque, reflective or absorbent. With a specifically designed combination of coatings and doped construction glass (substrate), the transparent walls or windows in the space craft would provide the interior protection expanded into x-ray range of electromagnetic-spectra.

Glass walls with pre-designed mapping of UV-transparency will be especially effective for energy and observation devices, and in particular for space farms. The desired UV transparency or opaque local optics of the wall will be provided by the appropriate coating design. Surface electrical conductivity of all dielectric materials may be tailored up to metallic level. In turn, the surface of metals may be coated with nearly perpetual dielectric skin and protected from mechanical erosion, and where it is required—from virtually any chemical or electrochemical attacks. In the case of light metals, such as aluminum, magnesium, beryllium alloys, the coatings are effective up to melting points of the respective substrate metal. Furthermore, protected beryllium becomes actually harmless for humans. In the further development, a smart functionally graded doped metal-carbon hierarchical composite of atomic scale would be deposited upon the rigidizing coating for space control sensors and systems. The basic design of such a smart skin for the flying apparatus have been preliminary developed.

One-micron thick SSC coatings provide effective protection against all three indicated aggressive factors, as well as protection of the interior against of loss of air or other filling gas, that should be important for large-scale inflatable. It was demonstrated in systematic long-term tests, 1-micron thick SSC coatings is more effective gas barrier than 500-micron thick ultra-dense Teflon. Besides, SSC coatings will make the coated plastic structure more rigid. SSC coatings will be deposited upon thermoplastic or inflatable structures directly in space. Deposition technology and equipment design would not limit the dimension of the substrate structure. Typically, one deposition module, or gun would be able to equalize the rigidity of the inflatable up to ˜10-mkm thick steel foil with deposition rate of at least 10 square meters of the inflatable external surface per hour, and a number of modules would conduct deposition simultaneously. For instance, 40 modules may regidize 10,000 sq. m of the inflatable external surface per 24 hours or 1 sq.km during about 3 months. For addition to such global rigidizing, special modules may realize a wideband beam forming by a patterned deposition of thicker coatings. Total weight of the coating will be about up to 1.5 g/sq. m or 1.5 t/sq. km for 1 mkm-thick steel equivalent, or 1,500 t/km² to form the 1-mm thick wall sustaining atmospheric pressure inside. This estimate is based on a currently available value of tensile strength, and it may be essentially improved with further development of the technology.

The coatings may be deposited upon glass, various plastics, metals, semiconductors. In many cases the strength of interface bonding exceeds the intrinsic strength of the substrate. Strong adhesion combined with superior mechanical properties of synergetic carbon reinforces coated substrates due to prevention of crack nucleation and propagation as it was demonstrated for variety of coated materials. For example, accordingly to statically reliable systematic tests, 1-micrometer thick coatings provides double to triple increase of the critical angle of bending of glass sheets and silicon substrates before fracture and increases tensile strength of 20-micrometer aluminum foil by about 25%. Thermal shock resistance of the coated substrate materials also increases. As the result, glass and thermoplastics shaped by blowing and drawing directly in space and superficially reinforced and functionalized with synergetic carbon become feasible construction materials for spacecrafts while inflatable structures made rigid with synergetic carbon coatings are appropriate for super large space crafts. The on-orbit deposition of synergetic carbon coatings will be conducted after glass, thermoplastic and/or inflatable structure have been shaped according to the pre-designed geometry.

For the purpose of present invention, it is essential feature of glass that is the best known construction material for vacuum devices. It can preserve vacuum or compressed gas during virtually unlimited time, it may be shaped into pre-designed complex shape by blowing and drawing without mechanical tool or assembling, its surface possesses superior aerodynamic quality, it does not undergo electrochemical reactions and corrosion while contacting with other materials. Its tensile strength, normally between 280 and 560 kg per sq cm (4000 and 8000 lb per sq in), can exceed 7000 kg per sq cm (100,000 lb per sq in). Depending on the composition, some glass will melt at temperatures as low as 500° C. (900° F.); others melt only at 1650° C. (3180° F.).

It is also important for the purpose of present invention that the obsidian is well known as a natural material possessing unique thermal-mechanical properties between the rocks, and it is especially viable for construction which may undergo to extreme thermal conditions. The obsidian is stronger than most of major crystalline rocks even at 600° C. It is particularly important for the purpose for present invention that the obsidian and the rocks of similar to obsidian chemical composition are well known by the contemporary science and space exploration as the abundant materials in solar system. Basaltic glasses found on Moon and Mars. True obsidian contains ˜70% of silica, while the average content of silica on the surface of Moon is about 64%. However, there is a little doubt, the enriched by silica rocks feasible for direct transformation into obsidian may be widely found on the Moon. It is easy to find the virtually ready raw material convertible into obsidian by the focused solar energy, or even ready forms as obsidian on the outer planets, while the metals require metallurgy. For economically sound energy and time saving technology requiring minimum resources on the remote outer lands, it is important that the rocks on the Moon are primordially crashed and ready for melting. The only simple mechanical classification and stratum arrangement is needed, and the technology is virtually dust free. Thus, production of excellent construction material may be realized on the Moon for the Moon-based stations or for spacecrafts. In the last case, the obsidian material or preformed structure may be launched into the space saving more than 95% energy (indeed, saving more than 99% of energy, taking into account that solar energy on the Moon surface is free and unlimited, + on the Moon the continuous solar day exceeds 300 hours without the weather limitations). A preliminary analysis accordingly to this invention shows that one 250-m² reflector may scan the 10-cm thick stratum of crashed rocks converting it in the artificial obsidian plates or breaks with the rate of about 1000 m² per lunar day.

Obsidian was the first hard material employed for weapon, mechanical tool and medical instrument, and it is used in some cases for the last purpose even contemporarily. A broad exploration of the space is at the beginning, and the basic material approach should have some similarity with the exploration of Earth surface by the early civilizations when the most naturally abundant materials used for both, constructions and tool. Obsidian has unlimited resources in Solar system. For instance, the surface of Mercury consists of crashed basalt close the Moon' basalt by composition, e.g. virtually ready raw mass for obsidian production, while the solar constant on the Mercury is 9140 W/m² vs. 1369 W/m² on the Earth, and launch velocity (first cosmic velocity) and escape velocity (second cosmic velocity) on the Mercury are correspondingly 3 km/s and 4.3 km/s vs. 8.3 and 11.1 km/s on the Earth. The asteroids are apparently also mostly consist of basalt-like rocks. Thus, obsidian—is potentially global material. Hence, eventually the obsidian-based space structures will evolve into archipelago with space construction docks—systems of stationary orbiting spacecrafts and devices, such as reflectors, deposition guns, etc. Eventually, the proposed materials and technology may be applied for technical constructions and human dwellings on the Moon and Mars. Indeed, its employment on the Moon may begin as soon as the major concepts described in this disclosure are modeled and detailed on the Earth and tested and assured in the space environment. Realistically, the first research-design-test project, including the flight qualification, may be realized during period of about three to four years.

What is claimed is:

1. A spacecraft structure or other structure built on the surface of an outer celestial body possessing solid land platform including planets, a natural satellite or asteroid, wherein said structure is made of a glass including artificial glass, natural glass, volcanic glass, obsidian, artificial obsidian or thermoplastic.

2. The spacecraft structure according to claim 1, wherein said structure is formed in space or on the surface of an outer celestial body by focused solar irradiation.

3. The spacecraft structure according to claim 2, wherein the process of focused solar irradiation comprises: fabricating an initial hollow structure and retaining the air in said hollow structure or filling said hollow structure with gas under pre-designed pressure; sealing said hollow structure containing the air or gas whereby the hollow sealed structure is built on the Earth and launched into the space, or fabricated in space, or built on the land platform of an outer celestial body; local heating of said structure by said focused solar irradiation up to the pre-designed temperature T1 required for making the material sufficiently soft and simultaneous heating of said structure by focused solar irradiation distributed over a larger area of the surface of said structure, said larger area of said structure heated up to the pre-designed temperature T2<T1 required for increasing the average temperature of the air or other gas encompassed in the interior of said hollow structure and therefore providing internal pressure inside of said hollow sealed structure; said local focused heating of said structure combined with said heating distributed over a larger area of the surface of said structure being continued during the pre-designed and/or real-time controlled period accordingly to the desired change of its local shape under internal gas pressure; subsequent discontinuing said heating or decreasing said local heating after the moment when said structure had acquired said pre-designed local shape; opening said structure or retaining said structure sealed after said pre-designed shape of said structure is formed, and releasing or retaining the air or gas in the interior of said structure correspondingly to the technical requirements of the structure.

4. The spacecraft structure according to claim 3, wherein said shape forming process is realized in multiple fields of the structure simultaneously or consecutively as required for providing said structure with the final required shape.

5. The spacecraft structure according to claim 4, wherein the focusing of solar irradiation and directing it to the said structure is realized with ultra-light weight reflectors being installed in free space on spacecrafts.

6. The spacecraft structure according to claim 1, wherein said glass structure is fabricated artificially on the surface of the outer celestial body by melting natural rocks on the surface of said celestial body by focused solar irradiation.

7. The spacecraft structure according to claim 6, wherein the focused solar irradiation is realized with reflectors installed on the surface of the outer celestial body, said reflectors being constructed of natural or artificially fabricated obsidian.

8. The spacecraft structure according to claim 1, wherein said artificial obsidian or artificial glass contains micro- and/or nano-inclusions, said inclusions being similar to natural obsidian with a pre-designed size distribution and chemical composition.

9. The spacecraft structure according to claim 1, wherein the coatings can comprise quasi-amorphous carbon (QUASAM™) coatings, Hard graphite-like material bonded by diamond-like framework and are deposited upon the structures formed in space or built on the outer celestial bodies whereby the coatings improve the mechanical properties of said glass and/or obsidian components of said structure and protect said plastic components of said structures against chemical and mechanical erosion, solar and other cosmic irradiation.

10. The spacecraft structure according to claim 9, wherein the coatings are smart coatings doped with metals, said metal doping is functionally distributed upon the surface of said structure including metal-doped SSC coatings, said coatings provide functionally distributed variation of optical properties or electrical properties or radio wave reflection, transmission, reception properties or local mechanical flexibility of said structures.

11. The spacecraft structure according to claim 10, wherein the deposition technique for fabrication of coatings is based a on a multi-chamber, multi-cascade remote plasmatron, said remote plasmatron generating the flux of energetic precursor particles and directing said flux to the surface of said structure.

12. The spacecraft structure according to claim 2, wherein said smart armor comprises rigid and flexible components, said flexible components including chain armor are self-shaping under a tensile force provided by the inflatable components of said structure.

13. The spacecraft structure according to claim 1, wherein said glass components are integrated by means of functionally graded transitions (interfaces) glass-to-plastics, said plastics are preferably selected from silicon-organic family of plastics
